(19) United States
(12) Patent Application Publication
(10) Pub. No.: US 2026/0226283 A1
(43) Pub. Date: Aug. 6, 2026

(54) POLYMER MATRIX COMPOSITES AND METHODS FOR MANUFACTURING THE SAME

(71) Applicants: Arvind Agarwal, Miami, FL (US); Luiza Benedetti, Miami, FL (US); Abhijith Kunneparambil Sukumaran, Miami, FL (US); Anil Lama, Miami, FL (US); Denny John, Miami, FL (US)

(72) Inventors: Arvind Agarwal, Miami, FL (US); Luiza Benedetti, Miami, FL (US); Abhijith Kunneparambil Sukumaran, Miami, FL (US); Anil Lama, Miami, FL (US); Denny John, Miami, FL (US)

(73) Assignee: The Florida International University Board of Trustees, Miami, FL (US)

(21) Appl. No.: 19/046,866

(22) Filed: Feb. 6, 2025

(51) Int. Cl. C09D 5/03; C08J 7/04; C09D 7/40; C09D 7/61; C09D 7/80; C09D 171/00; C09D 179/08; C08K 3/38; C08K 7/24

(52) U.S. Cl. CPC C09D 5/035; C08J 7/0427; C09D 5/031; C09D 7/61; C09D 7/67; C09D 7/70; C09D 7/80; C09D 171/00; C09D 179/08; C08J 2323/06; C08J 2379/02; C08J 2379/08; C08J 2471/10; C08J 2479/08; C08K 2003/385; C08K 7/24; C08K 2201/011

(57) ABSTRACT

Systems and methods are provided for manufacturing polymer matrix composites (PMCs). Polymers (e.g., polyimide (PI), polyether ether ketone (PEEK)) can be reinforced with a boron nitride (BN) material, such as one-dimensional (1D) BN nanotubes (BNNTs) and/or two-dimensional (2D) BN nanoparticles (BNNPs). The PMCs can be manufactured using cold spray technology, which enables rapid layer deposition and additive manufacturing of complex polymer composite parts using significantly lower pressures than sintering uses.

### GOVERNMENT SUPPORT

This invention was made with government support under W911NF-20-2-0256 awarded by the Army Research Laboratory-Army Research Office. The government has certain rights in the invention.

### BACKGROUND

High-temperature polymers are a specialized class of materials designed to maintain their mechanical and chemical properties under extreme thermal conditions, typically exceeding 200 °C. These polymers, including polyimide (PI), polyether ether ketone (PEEK), and polybenzimidazole (PBI), are used in demanding applications where conventional plastics would degrade or fail. Their unique molecular structures provide exceptional thermal stability, chemical resistance, and mechanical strength, making them ideal for aerospace, automotive, and electronics industries. High-temperature polymers are often employed in components such as engine parts, electrical insulators, and seals, where they ensure reliability and performance in harsh environments.

### BRIEF SUMMARY

Embodiments of the subject invention provide systems and methods for manufacturing polymer matrix composites (PMCs). Polymers (e.g., polyimide (PI), polyether ether ketone (PEEK)) can be reinforced with a boron nitride (BN) material, such as one-dimensional (1D) BN nanotubes (BNNTs) and/or two-dimensional (2D) BN nanoparticles (BNNPs). The PMCs can be manufactured using cold spray technology. The combination of a solid-state deposition technique for metals that can also be applied to polymers, and the addition of BN (in BNNT and BNNP (e.g., hexagonal BN (hBN)) form) leads to a lightweight composite with promising tribological and radiation shielding applications. Cold spray technology enables rapid layer deposition and additive manufacturing of complex polymer composite parts using significantly lower pressures than sintering uses. Further, cold spraying is the only one-step solid-state deposition mechanism capable of processing (or configured to process) polymers, and it is therefore of high interest for industrial and academic purposes.

In an embodiment, a PMC can comprise a polymer and a boron nitride (BN) material dispersed in, and reinforcing, the polymer. The BN material can comprise BNNTs and/or BNNPs (e.g., hBN). The PMC can be formed/manufactured by a cold spraying technique. The polymer can be, for example, PI or PEEK. A weight percentage of the BN material in the PMC can be in a range of, for example, from 0.01 wt% to 25 wt% (e.g., 0.1 wt% to 10 wt%, 1 wt% to 6 wt%, 2 wt% to 5 wt%, about 2 wt% or about 5 wt%).

In another embodiment, a method of forming a PMC can comprise: forming a composite powder comprising a polymer and a BN material; and performing a cold spraying process, using the composite powder as a feedstock for the cold spraying process, to form the PMC on a substrate. The BN material can comprise BNNTs and/or BNNPs (e.g., hBN).The forming of the composite powder can comprise: dissolving a BN powder comprising the BN material in a solvent (e.g., isopropyl alcohol (IPA)) to provide a solution; performing an ultrasonication process (e.g., a tip and bath ultrasonication process) on the solution to break agglomeration and disperse the BN material; and after performing the ultrasonication process, combining the BN material with a polymer powder (comprising the polymer) and performing ball milling on the BN material and the polymer powder to give the composite powder. The composite powder can have a particle size in a range of, for example, from 20 micrometers (μm) to 50 μm. The composite powder can comprise (mostly or all) spherical particles. The polymer can be, for example, PI or PEEK. A weight percentage of the BN material in the PMC can be in a range of, for example, from 0.01 wt% to 25 wt% (e.g., 0.1 wt% to 10 wt%, 1 wt% to 6 wt%, 2 wt% to 5 wt%, about 2 wt% or about 5 wt%). The weight percentage of the BN material in the PMC can be the same as a weight percentage of the BN material in the composite powder. It can be the case that the substrate has undergone no blasting, polishing, preheating, or other pretreatment prior to the forming of the PMC on the substrate. The substrate can comprise or be, for example, low-density polyethylene (LDPE), polyethyleneimine (PEI), and/or polyamide-imide (PAI).

### BRIEF DESCRIPTION OF DRAWINGS

FIG. 1A shows a schematic view of preparation of composite polyimide/boron nitride (BN) powder, including unzipping of BN nanotubes (BNNTs)by tip sonication followed by ball milling with polyimide (PI) and hexagonal boron nitride (hBN), according to an embodiment of the subject invention.

FIG. 1B shows scanning electron microscope (SEM) images of synthesized composite PI-hBN powder. The scale bar for the top image is 1 micrometer (μm), and the scale bar for the bottom image is 100 nanometers (nm).

FIG. 1C shows SEM images of synthesized composite polyether ether ketone (PEEK)-BN nanoparticle (BNNP) powder (i.e., PEEK-BNNP powder).

FIG. 2A shows a schematic illustration of PI-BN coating/additive manufacturing using a high-pressure cold spray system, according to an embodiment of the subject invention.

FIG. 2B shows a schematic illustration of PI-BN coating/additive manufacturing using a low-pressure cold spray system, according to an embodiment of the subject invention.

FIG. 3 shows a schematic illustration of three-dimensional (3D) printing (additive manufacturing) using cold spray technology, according to an embodiment of the subject invention.

FIG. 4A shows images of high-pressure cold-sprayed pure PEEK coating. The scale bar in the bottom-left SEM image is 50 μm, and the scale bar in the bottom-right SEM image is 5 μm.

FIG. 4B shows images of high-pressure cold-sprayed PEEK (with 2 wt.% BNNP) coating. The scale bar in the bottom-left SEM image is 50 μm, and the scale bar in the bottom-right SEM image is 0.5 μm.

FIG. 5A shows an image of low-pressure cold-spray of PI with 2 wt.% hBN on a low density polyethylene (LDPE) substrate.

FIG. 5B shows an image of a PI coating (with 2 wt.% hBN) on a LDPE, a polyethylenimine (PEI) substrate, and a polyamide-imide (PAI) substrate, each with 100 µm thickness.

FIG. 5C shows SEM images of a top surface of a PI coating (with 2 wt.% hBN) on LDPE, showing a high degree of deformation. The scale bar for the left image is 50 μm, and the scale bar for the right image is 5 μm.

FIG. 5D shows an energy-dispersive X-ray spectroscopy (EDS) map of a top surface microstructure, showing good dispersion of BN flakes. The EDS map is over SEM images. The scale bar for the left image is 5 μm, and the scale bar for the right image is 1 μm.

FIG. 6A shows a schematic view of wear resistance enhancement provided by a BN lubrication film, according to an embodiment of the subject invention.

FIG. 6B shows a schematic view of the neutron shielding effect of BN material, and a shielding mechanism of the BN material, according to an embodiment of the subject invention.

### DETAILED DESCRIPTION

Embodiments of the subject invention provide systems and methods for manufacturing polymer matrix composites (PMCs). Polymers (e.g., polyimide (PI), polyether ether ketone (PEEK)) can be reinforced with a boron nitride (BN) material, such as one-dimensional (1D) BN nanotubes (BNNTs) and/or two-dimensional (2D) BN nanoparticles (BNNPs). The PMCs can be manufactured using cold spray technology. The combination of a solid-state deposition technique for metals that can also be applied to polymers, and the addition of BN (in BNNT and BNNP (e.g., hexagonal BN (hBN)) form) leads to a lightweight composite with promising tribological and radiation shielding applications. Cold spray technology enables rapid layer deposition and additive manufacturing of complex polymer composite parts using significantly lower pressures than sintering uses. Further, cold spraying is the only one-step solid-state deposition mechanism capable of processing (or configured to process) polymers, and it is therefore of high interest for industrial and academic purposes.

PI is a category of high-performance thermoset polymers known for their outstanding combination of mechanical strength, thermal stability, and chemical resistance. They find extensive applications in mechanical and tribological settings, especially aerospace structure components such as bearings, bushings, seals, guides, gears, and valve parts. PEEK is a high-performance thermoplastic known for its exceptional mechanical strength, chemical resistance, and ability to withstand high temperatures, with a melting point of about 343 °C (649 °F). PEEK is widely used in the aerospace, automotive, electronics, and medical industries due to its stability and durability under extreme conditions. PEEK components are found in high-stress, high-temperature applications like engine parts, transmission systems, and medical implants. Its resistance to a wide range of chemicals and excellent wear resistance further enhance its suitability for demanding applications.

Though, both PI and PEEK are prone to experiencing premature wear when exposed to extreme conditions, including thermal cycling, high vacuum environments, and intense space radiation. In addition, their reliability in terms of component longevity and mission endurance is compromised by the subpar tribological performance of PI at elevated operating temperatures and the risk of brittle fractures resulting from severe solar particle events (SPEs) and galactic cosmic radiation (GCR). Reinforcing materials can be added to these high-temperature classes of thermoplastic and thermoset polymers to produce PMCs to improve the tribological and radiation shielding properties for demanding applications. 1D BNNTs and 2D BNNPs (e.g., hBN) are great candidates for enhancing these properties.

BN possesses exceptional mechanical properties and is thermally stable up to 1000 ^{o}C, as opposed to the thermal stability of 400 ^{o}C for carbon nanotubes (CNTs). The BN structure presents high thermal conductivity (4000 Watts per meter-Kelvin (W/mK)), low friction, and excellent solid lubricity due to the strong in-plane covalent bonds and weak interlayer van der Waals forces, which lead to the formation of a transfer layer during sliding. Further, BN is an exceptional radiation shielding material, with a high neutron absorption capacity (σ = 760 barns) that is significantly higher than that of graphene (value for C ≈ 0.0035 barns) and 500 times higher than that of concrete. The large-scale production of BN-reinforced PMCs and the integration of hBN/BNNTs into high-temperature polymers is very challenging, and BN-reinforced PI-PMCs on a laboratory scale is not the same as commercialization and industrial production.

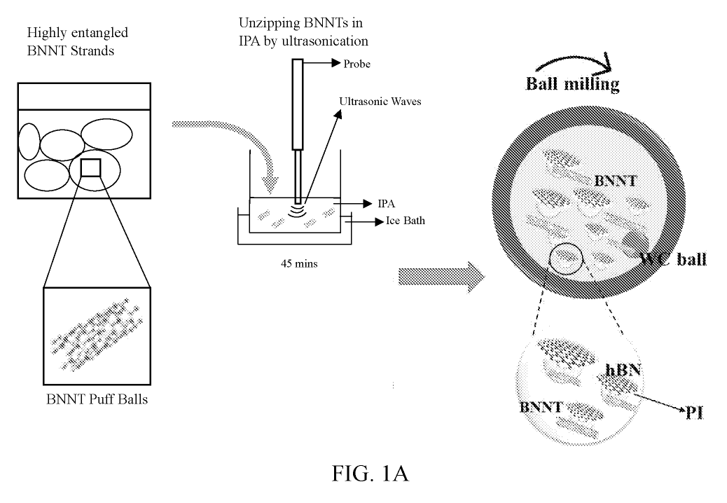

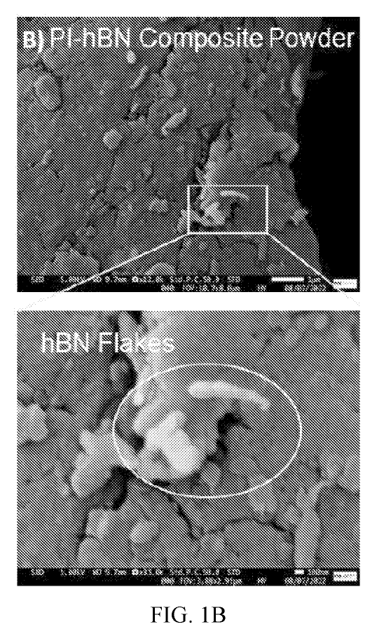

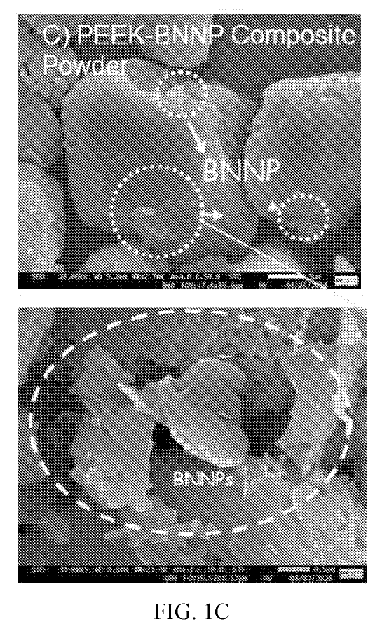

Cold spraying is a powder-based solid-state three-dimensional (3D) printing technique. Compared to conventional laser-based 3D printing or other thermal spray techniques, cold spraying undergoes a temperature (T) of much, much less than the melting temperature (Tₘ) without melting the feedstock materials. This is crucial for polymeric materials because heating PI and/or PEEK above its imidization temperature may compromise inherent mechanical and thermal properties. Feedstock powder travels at supersonic speed (e.g., velocity of 1000 meters per second (m/s) or more) in cold spraying, and the particles are severely deformed upon impact. Deformation leads to bonding between the particles and the formation of a desired structure. The cold spray process can retain the pristine properties of the polymer matrix, but the additional deformation also provides extra strengthening without leading to any oxidation or melting. Feedstock powder must be prepared to achieve BN-reinforced PMCs. The feedstock powder requires BNNTs/hBNs/BNNPs to be homogeneously dispersed in the polymer matrix. In embodiments of the subject invention, a combination of ultrasonication mixing and ball milling techniques can be used to uniformly disperse BN-based fillers into a polymer powder feedstock so that the BN can be retained during the cold spray process (see also, e.g., FIG. 1A).

Embodiments of the subject invention provide a comprehensive technological solution for large-scale additive manufacturing of multi-functional high-temperature polymer-BN composites using a cold spraying technique. PI, PEEK and other high-temperature polymers combined with 1D BN materials and/or 2D hBN have never been deposited in the related art using a cold spraying technique. Embodiments of the subject invention include: synthesizing polymer composites with 1D-BNNT and/or 2D-hBN and BNNP at different concentrations; depositing these high-temperature polymer thermosets and thermoplastic composites using low- and high-pressure cold spray systems; and creating 3D parts of composites (e.g., PI composites) using cold spray as an additive manufacturing process.

The synthesis of composite powder with 1D-BNNT and/or 2D-hBN agents follows a solution mixing involving bath and tip sonication methods to break agglomeration and disperse BNNTs and hBNs. These reinforcing agents can be added to the polymer powder using, for example, ball milling at lower rotation speeds (e.g., in the lower 20% or the lower 10% of a typical range of rotation speeds used in the ball milling art) to achieve homogeneous distribution without damaging the polymer particles morphology. The resultant powders are spherical, and the size of particles can be in a range of, for example, from 20 micrometers (μm) to 50 μm, which is ideal for the cold spray process.

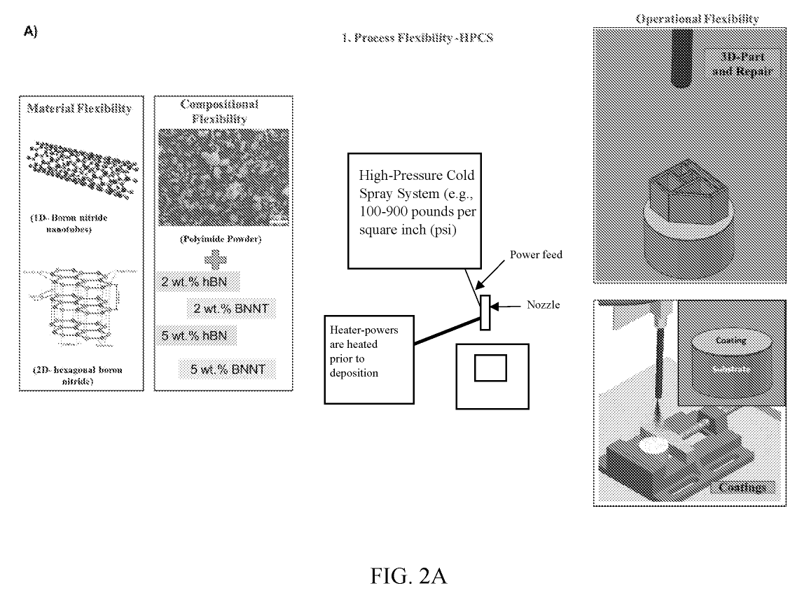

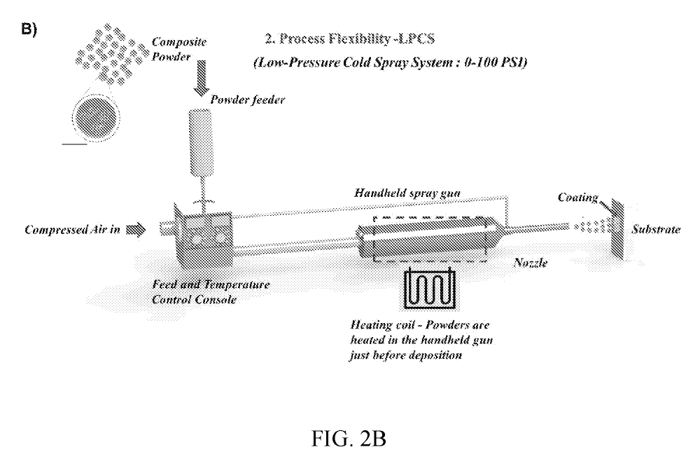

FIG. 1B illustrates a composite PI-hBN powder created through dispersion and ball milling at the ColRAD laboratory of Florida International University (FIU) in Miami, Florida, United States. FIG. 1C depicts a thermoplastic PEEK-BNNP powder generated by solvent mixing for cold spray applications at FIU. The nanocomposite powder combination can be sprayed using a high-pressure system (see FIG. 2A) and/or a low-pressure system (see FIG. 2B).

Cold-spray technology is a one-step process that uses significantly lower pressures and much shorter times than sintering. In addition, low-pressure cold spray deposition enables the production of structures on the moon and in space, as the system is lightweight and portable. Low pressure cold spray systems use compressed air as the propellent medium, so it is much more economical compared to other techniques. Also, a cold spray system mounted on a 6-axis robot can deposit PI-BN powders to perform near net shaped complex 3D parts quickly.

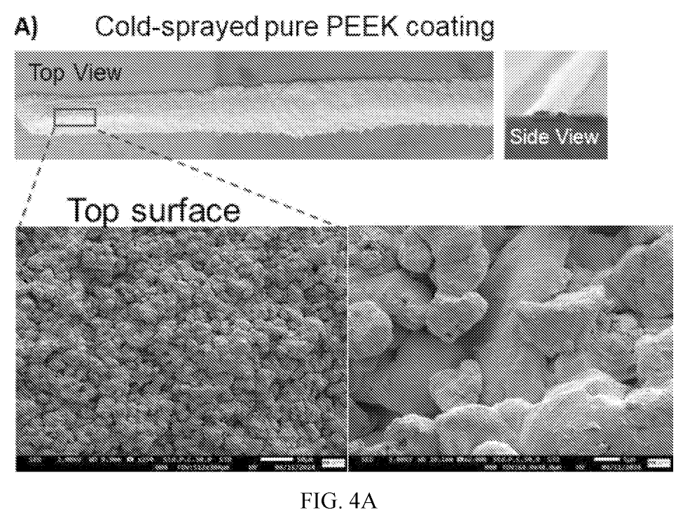

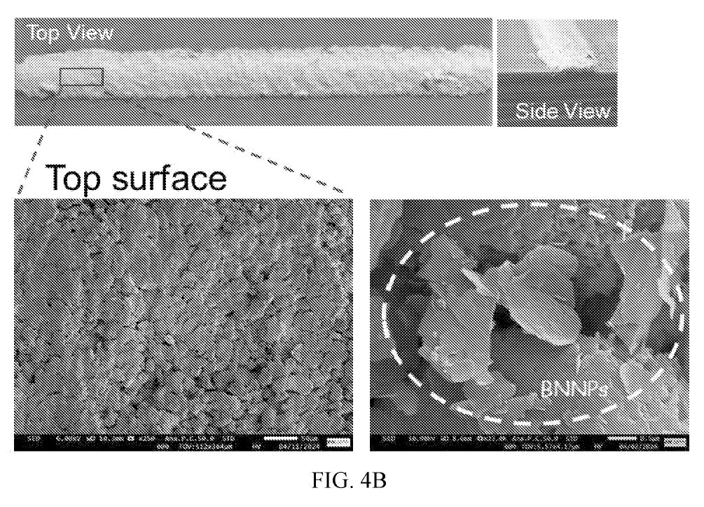

FIGS. 4A and 4B show images and microstructures of high-pressure cold-sprayed coatings developed at FIU ColRAD laboratory. FIG. 4A shows a pure PEEK coating with a thickness of 600 µm, while FIG. 4B shows a PEEK coating containing 2 wt.% BNNP, with BNNP particles embedded within the coating.

Embodiments of the subject invention provide solid-state deposition of high-temperature thermoset (e.g., PI) and thermoplastic (e.g., PEEK) composites by cold-spray techniques. Cold-spray is the only solid-state deposition technology capable of spraying polymers. PI is a high-performance and high-temperature polymer (Tg of about 340˚ C) with outstanding thermal, mechanical, and tribological properties for aerospace application. Therefore, it is advantageous as a matrix structure in polymer composite parts.

Embodiments of the subject invention also provide synthesis of composite powders integrating 1D BNNTs and/or 2D hBN at varying concentrations. The combination of 1D and 2D nanomaterials significantly enhances the mechanical, thermal, tribological, and radiation shielding properties, as the nanotubes connect the platelets and create a network structure. It is possible to obtain a dispersed structure of polymer/reinforcing agents using ultrasonication/tip sonication coupled with ball milling technology, which can efficiently mix a wide range of 1D/2D nanomaterial concentrations and successfully disperse them in a polymer powder matrix (see also FIG. 1A). FIG. 1B shows microscopic images of a composite PI-hBN powder created through dispersion and ball milling (this composite was created at the ColRAD laboratory of FIU). FIG. 1C shows microscopic images of a thermoplastic PEEK-BNNP powder that can be used for cold-spray applications (e.g., at FIU).

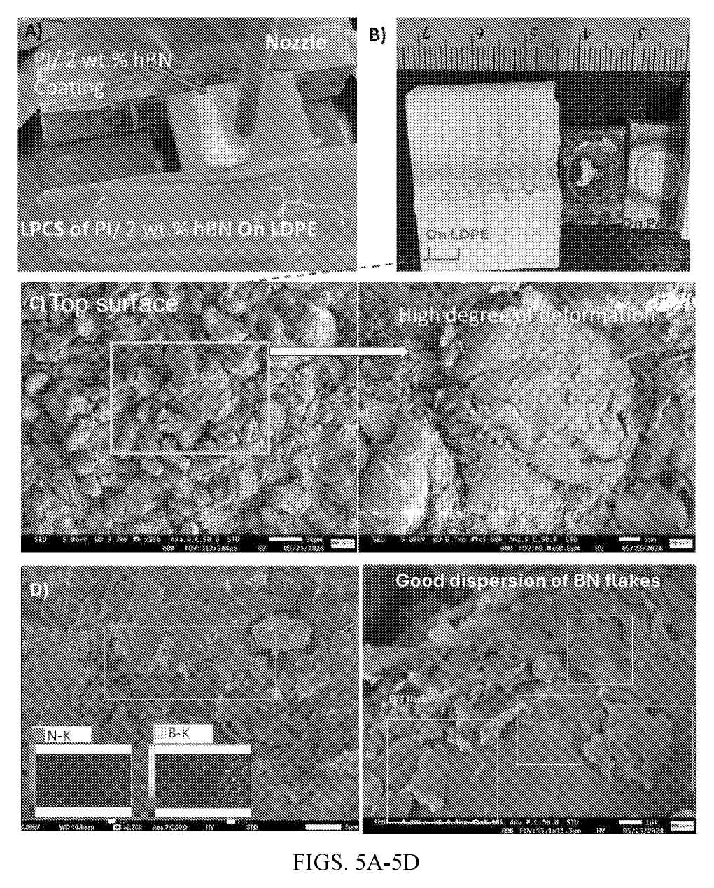

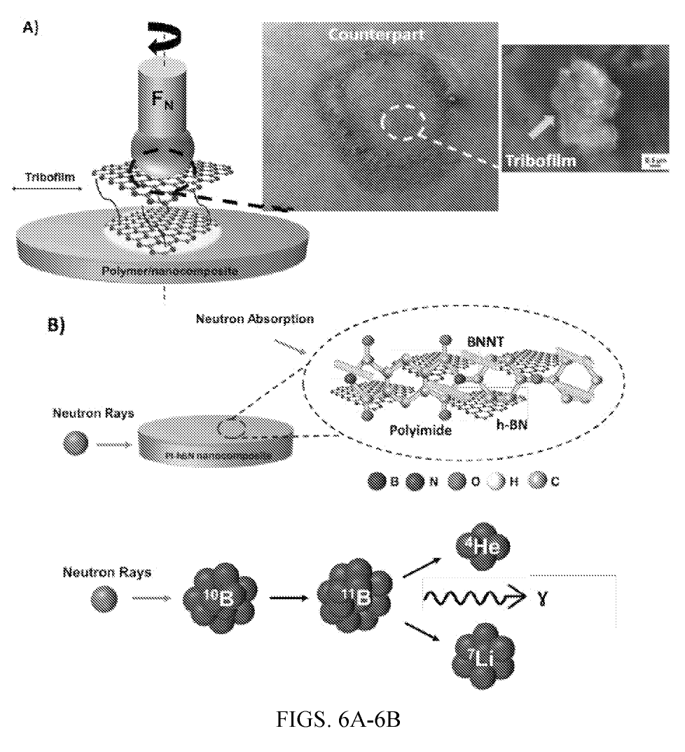

Composite cold-spray coatings of PI/BN can be used for wear, thermal, and radiation shielding applications. BN is the material that presents the best radiation shielding properties of those considered (see also FIGS. 5D and 6B). Further, the self-lubricating properties of 2D-hBN structure has advantages in tribology (see also FIGS. 5D and 6A). In addition, the thermal properties of 1D and 2D BN is comparable to those achieved with carbon nanotubes and graphene. FIG. 5A shows cold-sprayed PI (with 2wt.% hBN powder) using a low-pressure gun onto a low-density polyethylene (LDPE) substrate. FIG. 5B shows the deposited PI (with 2 wt.% hBN) coatings (thickness of about 100 µm) on LDPE, polyethyleneimine (PEI), and polyamide-imide (PAI) high-performance polymer substrates that offer higher strength, stiffness, and wear resistance. FIG. 5C depicts a high degree of deformation of PI on the top surface micrograph of the coating, and FIG. 5D depicts good dispersion of BN flakes across the coating surface.

Embodiments of the subject invention provide flexibility in deposition using low-pressure and high-pressure cold-spray systems. Thermoset and thermoplastic composites can be deposited using high- and low-pressure cold-spray systems, facilitating their use in structures manufactured in space (see also FIGS. 2A and 2B). Embodiments also provide a single-step manufacturing process for multifunctional composite coatings and parts that can be used to protect against harsh environments. Cold spraying is a single-step technology, thereby reducing time and cost of operation. It does not require significantly high pressures or heating times (e.g., sintering), and it can deposit a layer of material within minutes (e.g., less than 60 minutes, less than 30 minutes, or less than 10 minutes) without the need to heat up the system in advance (see also FIGS. 4A and 4B). The high-velocity impact of the particles in the cold spray enables the elimination of surface preparation such as blasting, polishing, preheating, or any other pretreatments. That is, embodiments can include cold spraying onto a substrate that has not had any surface preparation including any blasting, polishing, preheating, or other pretreatment.

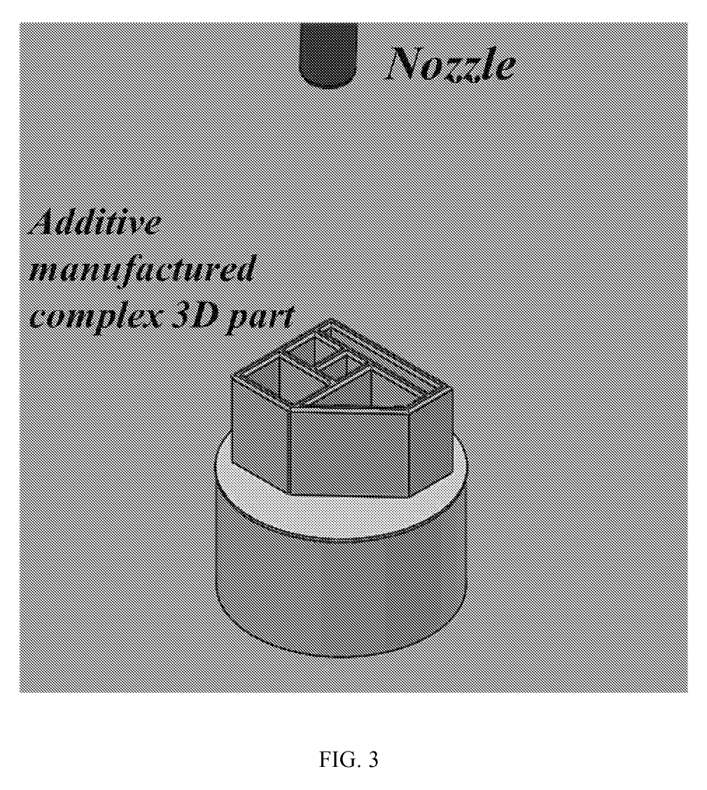

The additive manufacturing aspect of cold spraying can be employed in embodiments of the subject invention to manufacture BN-reinforced polymer composite parts of complex geometry. Cold spraying enables the production of full parts of complex shapes. Using this technology as an additive manufacturing method enables easy production of polymer-composite parts, saving time, cost, and feedstock waste (see also FIG. 3).

Embodiments of the subject invention provide a comprehensive solution to mass-produce lightweight, high-strength PI-based PMCs. Compared to related art manufacturing techniques, cold spraying of PMC has several advantages. First, a high-strength composite deposition can be achieved via low- and high-pressure cold-spray systems. This single-step manufacturing technology is the only solid-state deposition technique available for polymers and can be employed (in embodiments) to manufacture high-performance thermoset and thermoplastic composites for tribological and radiation shielding applications. Due to the low operational temperatures of the cold-spray process, no curing or degradation occurs, thereby maintaining the pristine powder properties. Second, the process can be easily scaled up. As opposed to sintering, which is limited by die size and shape, cold spraying can quickly scale up. With the aid of a turntable and a robotic arm, cold spraying can manufacture BNNT-reinforced PI PMCs of any size and shape to produce complex parts. Third, cold spraying is portable and can provide service on demand. Because it is a low-temperature process, cold spraying can be handheld and applied directly where needed, drastically reducing turnaround time and cost. Fourth, several parts made of PI, such as bearings, bushings, seals, guides, gears, and valve parts are used for tribological applications and can be manufactured by cold spraying because of the low coefficient of friction and solid lubricity of BN. The addition of BN structures significantly reduces the coefficient of friction of PMCs, and can successfully overcome PI’s brittle fracture caused by extreme solar particle events (SPEs) and galactic cosmic radiation (GCR) in space. Also, the high strength of 2D-hBN (strength in a range of 10 gigaPascals (GPa) to 40 GPa) and 1D-BNNT (strength of about 61 GPa), combined with the thermal conductivity of BN structures (about 4,000 Watts per meter per Kelvin (W/m-K)) would benefit many other applications in the aerospace, automotive, and electronic industries. Fifth, there is no thermal transformation, providing the ability to preserve initial feedstock properties, scale large coating depositions, and repair depositions.

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/- 5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1

Two main steps included feedstock preparation and cold spraying of BN/PI and BN/PEEK composite powder. PI/PEEK powders with a particle size in a range of 10 μm to 60 μm were chosen as starting powder. Commercially available hBN powder with an average particle size of 5 µm (or about 5 µm), BNNPs with a particle size of 70 nanometers (nm) (or about 70 nm), and BNNTs in the form of puffballs were used as fillers. The first step included using ultrasonication/tip sonication to break down the entanglement of BN. Then, the BN was dispersed uniformly (2 wt.% and 5wt.% of BNNT or BNNPs or hBN in two different runs (i.e., 2wt.% for the first run and 5 wt.% for the second run)) using the bath sonication technique (see FIG. 1A).

Once the BN was well dispersed, the polymer powder (PI or PEEK (i.e., PI in one experiment and PEEK in another experiment)) was added to the sonicated solution. The BN-PI mixture was mechanically milled at low rotation speeds to achieve homogeneous distribution without damaging the polymer particles morphology. Similarly, PEEK/BNNP composite powders were also prepared for the cold spray process. The resultant powders were spherical and ranged in size from 20 µm to 50 µm, which is ideal for the cold spray deposition. FIG. 1B shows the composite PI-hBN powder synthesized by dispersion and ball milling in the ColRAD laboratory of FIU. FIG. 1C shows the thermoplastic PEEK-BNNP powder for cold spraying. A cold spray gun can be either attached to a robotic arm to 3D print any desired geometry (see FIG. 2A), or handheld and applied to where needed in the field (see FIG. 2B). FIGS. 4A and 4B show the coating images and microstructure of high-pressure cold-sprayed pure PEEK coating of 600 µm (or about 600 µm) thickness and PEEK/2 wt.% BNNP coating, with embedded BNNP particles in the coating, respectively.

A PI-BN cold spray coating or additive manufactured 3D part (see FIG. 3) can be developed for wear resistance and radiation shielding applications. FIG. 5A depicts the cold spray of PI/2wt.% hBN powder using a low-pressure gun onto an LDPE substrate. FIG. 5B shows the deposited PI/2 wt.% hBN coatings (thickness of about 100 µm) on LDPE, PEI, and PAI high-performance polymer substrates that offer higher strength, stiffness, and wear resistance. FIG. 5C shows a high degree of deformation of dispersed powder particles on the top surface micrograph of the coating, while FIG. 5D indicates good dispersion of BN flakes across the coating surface with the corresponding energy-dispersive X-ray spectroscopy (EDS) map. The solid lubricity of the BN layer during sliding enhanced the friction reduction and wear resistance (see also FIG. 6A), while the high neutron absorption cross-section of boron atoms absorbs the thermal neutrons and undergoes neutron decay to enhance the radiations shielding capabilities (see also FIG. 6B).

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A polymer matrix composite (PMC), comprising:
a polymer; and
a boron nitride (BN) material dispersed in, and reinforcing, the polymer,
the BN material comprising at least one of boron nitride nanotubes (BNNTs) and boron nitride nanoparticles (BNNPs), and
the PMC being formed by a cold spraying technique.

2. The PMC according to claim 1, the BN material comprising both BNNTs and BNNPs.

3. The PMC according to claim 1, the BN material comprising BNNPs, and
the BNNPs comprising hexagonal boron nitride (hBN).

4. The PMC according to claim 1, the polymer being polyimide (PI).

5. The PMC according to claim 1, the polymer being polyether ether ketone (PEEK).

6. The PMC according to claim 1, a weight percentage of the BN material in the PMC being in a range of from 0.1 wt% to 10 wt%.

7. The PMC according to claim 1, a weight percentage of the BN material in the PMC being in a range of from 1 wt% to 6 wt%.

8. A method of forming a polymer matrix composite (PMC), the method comprising:
forming a composite powder comprising a polymer and a boron nitride (BN) material; and
performing a cold spraying process, using the composite powder as a feedstock for the cold spraying process, to form the PMC on a substrate,
the BN material comprising at least one of boron nitride nanotubes (BNNTs) and boron nitride nanoparticles (BNNPs).

9. The method according to claim 8, the forming of the composite powder comprising:
dissolving a BN powder comprising the BN material in a solvent to provide a solution;
performing an ultrasonication process on the solution to break agglomeration and disperse the BN material; and
after performing the ultrasonication process, combining the BN material with a polymer powder and performing ball milling on the BN material and the polymer powder to give the composite powder.

10. The method according to claim 8, the composite powder having a particle size in a range of from 20 micrometers (μm) to 50 μm.

11. The method according to claim 8, the BN material comprising both BNNTs and BNNPs.

12. The method according to claim 8, the BN material comprising BNNPs, and
the BNNPs comprising hexagonal boron nitride (hBN).

13. The method according to claim 8, the polymer being polyimide (PI).

14. The method according to claim 8, the polymer being polyether ether ketone (PEEK).

15. The method according to claim 8, a weight percentage of the BN material in the PMC being in a range of from 0.1 wt% to 10 wt%, and
the weight percentage of the BN material in the PMC being the same as a weight percentage of the BN material in the composite powder.

16. The method according to claim 8, the substrate comprising low-density polyethylene (LDPE), polyethyleneimine (PEI), or polyamide-imide (PAI).

17. The method according to claim 8, the substrate having undergone no blasting, polishing, preheating, or other pretreatment prior to the forming of the PMC on the substrate.

18. A method of forming a polymer matrix composite (PMC), the method comprising:
dissolving a BN powder comprising a BN material in a solvent to provide a solution;
performing an ultrasonication process on the solution to break agglomeration and disperse the BN material;
after performing the ultrasonication process, combining the BN material with a polymer powder that comprises a polymer, and performing ball milling on the BN material and the polymer powder to give a composite powder that comprises the polymer and the BN material; and
performing a cold spraying process, using the composite powder as a feedstock for the cold spraying process, to form the PMC on a substrate,
the BN material comprising at least one of boron nitride nanotubes (BNNTs) and boron nitride nanoparticles (BNNPs),
the composite powder having a particle size in a range of from 20 micrometers (μm) to 50 μm,
the polymer being polyimide (PI) or polyether ether ketone (PEEK),
a weight percentage of the BN material in the PMC being in a range of from 0.1 wt% to 10 wt%,
the weight percentage of the BN material in the PMC being the same as a weight percentage of the BN material in the composite powder, and
the substrate having undergone no blasting, polishing, preheating, or other pretreatment prior to the forming of the PMC on the substrate.

19. The method according to claim 18, the BN material comprising both BNNTs and BNNPs, and
the BNNPs comprising hexagonal boron nitride (hBN).

20. The method according to claim 18, the substrate comprising low-density polyethylene (LDPE), polyethyleneimine (PEI), or polyamide-imide (PAI).
